(19) United States
(12) Patent Application Publication
(10) Pub. No.: US 2026/0049195 A1
(43) Pub. Date: Feb. 19, 2026

(54) PROCESS FOR THE DEPOLYMERIZATION OF MIXED AUTOMOTIVE PLASTICS

(71) Applicant: Basell Poliolefine Italia S.R.L., Milano (IT)

(72) Inventors: Shahram Mihan, Bad Soden (DE); Carl Gunther Schirmeister, Denzlingen (DE); Erik Hans Licht, Mainz (DE); Timo Hees, Mainz (DE); Gerd Mannebach, Münstermaifeld (DE); Volker Fraaije, Frankfurt am Main (DE)

(73) Assignee: Basell Poliolefine Italia S.R.L., Milano (IT)

(21) Appl. No.: 19/101,471

(22) PCT Filed: Aug. 3, 2023
(86) PCT No.: PCT/EP2023/071523

§ 371 Date: Feb. 5, 2025

(30) Foreign Application Priority Data
Aug. 10, 2022 (EP) 22189685.5

(51) Int. Cl. C08J 11/06

(52) U.S. Cl. CPC C08J 11/06

(57) ABSTRACT

A process for the recycling of automotive plastic waste including the steps of:
(i) sorting the automotive plastic waste (APW), thereby obtaining a plastic waste fraction containing at least 60% wt of a mixture of polyethylene (PE) and polypropylene (PP);
(ii) shredding, pelletizing, or both the fraction, thereby obtaining a plastic feedstock having a bulk density higher than 100 g/l;
(iii) depolymerizing the feedstock at 300-500° C., in the optional presence of a catalyst, thereby obtaining a depolymerization product and
(iv) collecting the depolymerization product and separating the depolymerization product into a liquid stream and a gaseous stream.

### FIELD OF THE DISCLOSURE

In general, the present disclosure relates to the field of chemistry. More specifically, the present disclosure relates to polymer chemistry. In particular, the present disclosure relates to the depolymerization of polymeric waste materials.

### BACKGROUND OF THE DISCLOSURE

Mixed post-consumer plastic waste from automotive applications is generated globally through repairs and the recycling of end-of-life vehicles. The various polymers, plastic/metal composites, and plastic/inorganic fillers composites used in automotive applications present challenges to mechanical reprocessing of the plastics.

In some instances, end-of-use cars are shredded and sorted in scrap car recycling plants to recover the metals. In some instances, a plastic waste fraction is recovered. In some instances, these automotive plastic waste streams are incinerated for energy recovery (quaternary recycling) because the plastic waste streams are contaminated. In some instances, these automotive plastic waste streams are processed by chemical recycling (also called tertiary recycling) technologies, including pyrolysis.

In some instances, the pyrolysis of mixed and unsorted automotive plastic waste contaminates the pyrolysis oil with heteroatoms and halogens. In some instances, the level of contamination prevents using the corresponding pyrolytic oil for fuel applications and as a feedstock for steam crackers.

### SUMMARY OF THE DISCLOSURE

In a general embodiment, the present disclosure provides a process for the recycling of automotive plastic waste including the steps of:
(i) sorting the automotive plastic waste (APW), thereby obtaining a plastic waste fraction containing at least 60% wt of a mixture of polyethylene (PE) and polypropylene (PP);
(ii) shredding, pelletizing, or both the fraction, thereby obtaining a plastic feedstock having a bulk density higher than 100 g/l;
(iii) depolymerizing the feedstock at 300-500° C. in the optional presence of a catalyst, thereby obtaining a depolymerization product; and
(iv) collecting the depolymerization product and separating the depolymerization product into a liquid stream and a gaseous stream.

### DETAILED DESCRIPTION OF THE DISCLOSURE

In some embodiment, the sorting of the APW yields a fraction, having a content of PE and PP higher than 70% wt. alternatively higher than 75% wt. As used herein, the term “polyethylene” includes members of the polyethylene family, plastomers, and elastomers of ethylene. In some embodiments, the members of the polyethylene family are selected from the group consisting of high-density polyethylene (HDPE), medium-density polyethylene (MDPE), linear low-density polyethylene (LLDPE), low-density polyethylene (LDPE), ultra-low density polyethylene (ULDPE). In some embodiments, the elastomers are made from or containing ethylene and a comonomer selected from the group consisting of butene-1, hexene-1, octene-1, and combinations thereof. As used herein, the term “polypropylene (PP)” includes propylene homopolymer, propylene copolymers with other alpha olefins, and heterophasic copolymers (HeCO). In some embodiments, heterophasic copolymers are made from or containing a crystalline fraction of propylene homopolymer or copolymer and an elastomeric amorphous fraction. In some embodiments, the elastomeric amorphous fraction is made from or containing a propylene/ethylene copolymer.

In some embodiments, the sorted fraction is made from or containing PP and PE polymers filled with inorganic materials. In some embodiments, the inorganic materials are selected from the group consisting of talc, silica, glass fibers, and glass beads.

As used herein, the term “non-olefin polymers” refers to polymers deriving from monomers made from or containing heteroatoms. In some embodiments, the amount of non-olefin polymers is lower than 5% wt. alternatively lower than 3% wt, alternatively lower than 2% wt, alternatively absent, in the sorted fraction. In some embodiments, the non-olefin polymers are selected from the group consisting of polyamides (PA), polycarbonate (PC), polyethylene terephthalate (PET), acrylonitrile styrene acrylate (ASA), polyoxymethylene (POM), acrylonitrile butadiene styrene (ABS), and halogenated polymers.

In some embodiments, metal rich parts are removed. In some embodiments, the metals are selected from the group consisting of iron, copper, aluminum, magnesium, and chromium. In some embodiments, the cumulative amount of metals in the sorted feedstock fraction is lower than 1% wt, alternatively from 0.1 to 0.7% wt, alternatively absent.

In some embodiments, the sorted fraction is a feedstock for recycling purposes, alternatively for a depolymerization process. In some embodiments, the present disclosure provides a feedstock for a recycling process made from or containing a sorted automotive plastic waste fraction made from or containing (a) at least 60% wt of a mixture of polyethylene (PE) and polypropylene (PP); (b) less than 5% wt of polymers deriving from monomers made from or containing heteroatoms (non-olefin polymers); and (c) less than 1% wt of metals selected from the group consisting of iron, copper, aluminum, magnesium, and chromium.

### Sorting

In some embodiments, a variety of techniques are used to separate materials in a polymeric waste stream. In some embodiments, moving beds, drums and screens, and air separators are used to differentiate materials by size, weight, or density. In some embodiments, the sorting technique is manual or automated. In some embodiments, Automatic Separation Techniques of waste plastics include dry sorting techniques, electrostatic sorting techniques, mechanical sorting methods (involves centrifugal force, specific gravity, elasticity, particle shape, selective shredding and mechanical properties), wet sorting techniques, and chemical sorting methods. In some embodiments, the wet sorting technique is a sink/float sorting method.

In some embodiments, the APW feedstock originates from scrap of end-of-use cars and the ferrous metal parts and cables are removed manually or via magnetic separators. In some embodiments, non-ferrous metal materials are separated via eddy current separators. In some embodiments, the non-ferrous metal materials are selected from the group consisting of aluminum, copper and zinc. In some embodiments, the eddy current separators are based on an eccentrically mounted pole system.

In some embodiments, density based separation is used for isolating the metal fraction, having a density higher than 2.5 g/cm³. In some embodiments, a plastic-rich fraction, having a density lower than 2.0 g/cm³, is obtained. In some embodiments, the plastic-rich fraction is subject to a further density separation step, thereby isolating a polyolefin rich fraction, having a density lower than 1.06 g/cm³.

In some embodiments, repair shops offer an alternative source of APW. In some embodiments, the repair-shop sourced APW is sorted based on applications of specific polymers, density and polymer composites for specific components. In some embodiments, colorless tanks with a density <1.0 g/cm³ are assigned to a polyethylene fraction. In some embodiments, the colorless tanks are cooling water expansion tanks. In some embodiments, black fuel tanks and black fuel hose with a density <1.0 g/cm³ are assigned to a fraction of halogenated materials.

In some embodiments, unpainted exterior parts with a dimension along one axis of >10 cm and density <1.06 g/cm³ are made from or containing PP and talc and assigned to a PP talc and mineral filled fraction. In some embodiments, unpainted exterior parts are selected from the group consisting of wheel house liners, wheel arch, and bumper guide rails.

In some embodiments, unpainted exterior parts with a dimension along one axis of >10 cm and density of 1.06-1.3 g/cm³ are assigned according to the material stamp on the parts to a non-polyolefin fraction. In some embodiments, unpainted exterior parts are selected from the group consisting of wheel house liners, wheel arch, and bumper guide rails. In some embodiments, the non-polyolefin fraction is made from or containing ASA, ABS, PC/ABS, or POM and assigned to an ASA, ABS, PC/ABS, and POM fraction. In some embodiments, polyamide parts are manually separated from the unpainted exterior parts and collected in a PA fraction.

In some embodiments, engine covers with a dimension along one axis of >10 cm and density of 1.06-1.3 g/cm³ are assigned to the PA fraction.

### Feedstock Treatment

In some embodiments, the sorted APW is shredded, pelletized, or both, thereby rendering the APW's particle size uniform and bulk density higher than 100 g/cm³, alternatively higher than 300 g/cm³, alternatively higher than 500 g/cm³.

In some embodiments, the polymeric waste material feedstock is in the form of pellets. In some embodiments, the pellets have a particle size from 1 to 20 mm, alternatively from 2 to 10 mm, alternatively from 2 to 8 mm. In some embodiments, the polymeric waste material feedstock is in the form of shredded flakes, pieces of film, or both. In some embodiments, the flakes or film have a particle size from 1 to 100 mm. As used herein, the phrase “having a particles size in a defined range” means that 90 wt. % of the particles have a particle size within the defined range. In some embodiments, particle size is determined by sieving or using a Beckman Coulters LS13320 laser diffraction particle size analyzer.

In some embodiments, the sorted APW is extruded prior to being employed as a feedstock. In some embodiments, the sorted APW is pelletized, and the pellets are employed as a feedstock.

### Depolymerization Process and Reactor

In some embodiments, the depolymerization is carried out in the presence or in the absence of a catalyst. In some embodiments, the depolymerization occurs at temperature ranging from 300 to 550° C., alternatively from 350 to 500° C.

In some embodiments, the sorted and treated APW, and optionally the catalyst, are introduced into a depolymerization unit and then heated, thereby achieving depolymerization. In some embodiments, gaseous fractions generated during depolymerization are discharged and conveyed to a condensation unit wherein a liquid stream and a gaseous stream are obtained from the gaseous fractions. In some embodiments, solid residue of the depolymerization is discharged via a solid discharge unit.

In some embodiments, the liquid depolymerization product is further separated. In some embodiments, the process further includes a step of distilling the liquid depolymerization product.

In some embodiments, the process yields a depolymerization product with a gaseous content ranging from 20 to 60 wt %, based on the combined weight of the gaseous and liquid depolymerization product.

In some embodiments, the gaseous fraction of the depolymerization product, has a high content of monomeric olefinic C₂-C₄-compounds. In some embodiments, the depolymerization product is generated in the presence of a depolymerization catalyst. In some embodiments, the monomeric olefinic C₂-C₄-compounds are useful for further processing. In some embodiments, the further processing is for the production of polymers. In some embodiments, the gaseous depolymerization product is directly used as a feedstock in cracking processes and subsequent polymerization. In some embodiments, the gaseous product is made from or containing light olefins and light alkanes and is transferred to a downstream cracker by passing the ovens, thereby producing polymerization grade monomer streams. In some embodiments, other side products are cracked in the oven. In some embodiments, the other side products are selected from the group consisting of ethane, propane and butanes. In some embodiments, the steps of treating the depolymerization product to obtain certain monomers is bypassed, thereby saving energy and reducing CO₂ output.

In some embodiments, the depolymerization process is carried out in a reactor including: (a) feeding devices for introducing polymeric waste material and catalyst into the reactor: (b) a pyrolysis device equipped with heating units, gas discharge units and a solid discharge unit; and (c) a condensation device.

In some embodiments, the reactor includes more than one pyrolysis unit.

In some embodiments, a variety of reactors is used for pyrolysis. In some embodiments, the reactor is an agitated vessel with rotating blades. In some embodiments, the reactor is a horizontal reactor equipped with a screw for homogenously mixing the polymeric waste material in the pyrolysis device throughout the depolymerization. In some embodiments, the residence time of the solids in the pyrolysis device is defined by adjusting the rotational speed of the screw.

In some embodiments and in such a reactor, the gas discharge units are distributed throughout the pyrolysis device and are provided with an outlet to discharge the gaseous fraction of the depolymerization and an inlet for introducing cleaning gas into the pyrolysis device.

In some embodiments, the gas discharge units are equipped with a filter membrane, thereby preventing solids from being present in the gaseous fractions after discharge from the pyrolysis device. In some embodiments, the gas discharge units are made of metallic or ceramic grain or fiber materials.

In some embodiments, the condensation device has several condensers. In some embodiments, the condensers are operated at different temperatures. In some embodiments, the temperatures of the condensers are set according to the boiling points of the condensates.

### Depolymerization Catalyst

In some embodiments, the depolymerization process works with pure thermal depolymerization. In some embodiments, the depolymerization process employs a depolymerization catalyst.

In some embodiments, the catalyst is selected from depolymerization/cracking catalysts used in thermocatalytic processes. In some embodiments, the catalyst is selected from the group consisting of metal oxides, heteropolyacids, mesoporous silica, and aluminosilicates catalysts. In some embodiments, the aluminosilicate is selected from the group consisting of halloysite, kaolinite, and zeolites. In some embodiments, the aluminosilicate is selected from the group consisting of zeolites. In some embodiments, the zeolites are selected from the group consisting of synthetic Y-type zeolite and ZSM-5.

In some embodiments, the catalyst is made from or containing, as the active component, an acidic compound deposited on a particulate non-porous support with the aid of a coating agent.

In some embodiments, the catalyst is effective in the depolymerization and easily separable from solid residue of the depolymerization process, thereby allowing for multiple uses.

In some embodiments, the catalyst is in particulate form. In some embodiments, the catalyst has a particulate non-porous support selected from the group consisting of sand, glass beads and metal particles. In some embodiments, the particulate non-porous support has a variety of shapes. In some embodiment, the shape is selected from the group consisting of spherical, cylindrical, and non-homogenous shapes. In some embodiments, the support is non-porous. As used herein, the term “non-porous” refers to being not permeable to gases, such as air, or liquids such as water. In some embodiments and for mixing with the polymeric waste material undergoing depolymerization, the support has an average particle size D50 of 0.2 to 20 mm, alternatively 0.5 to 10 mm, alternatively 1 to 8, alternatively from 1 to 6 mm, determined according to sieve analysis in accordance with ISO 3310-1/ASTM E11. In some embodiments, the test sieve apparatus of Retsch with woven wire mesh sieves (Ø 125 mm-20 μm) is the sieving device.

In some embodiments, sand is the non-porous particulate support.

In some embodiments, the acidic compound of the catalyst is selected from the group consisting of Al/Si mixed oxides, Al₂O₃, aluminosilicates, silica and zeolites. As used herein, the term “Al/Si mixed oxides” refers to a material made from or containing a mixture of Al₂O₃ and SiO₂, having a neutral structure.

As used herein, the term “zeolites” refers to crystalline microporous aluminosilicates which are built up from corner-sharing SiO₄— and AlO₄— tetrahedrons, having the structure Mₙ+x/n [AlO₂]-x(SiO₂)_{y}]+zH₂O with n being the charge of the cation M, and z defining the number of water molecules incorporated into the crystal structure. In some embodiments, the cation M is an alkaline, alkaline earth metal, or hydrogen ion. In some embodiments, the cation M is an ion selected from the group consisting of H⁺, Na⁺, Ca₂⁺, K⁺ and Mg₂⁺. Zeolites differ from mixed Al/Si oxides by defined pore structure and ionic character. In some embodiments, the zeolite employed as the acidic compound is selected from the group consisting of Zeolite Y, Zeolite Beta, Zeolite A. Zeolite X, Zeolite L and mixtures thereof. In some embodiments, the zeolite is selected from the group consisting of Zeolite Y and Zeolite Beta. In some embodiments, zeolites have the metal ion M substituted by a hydrogen. In some embodiments, the zeolite-type components are selected from the group consisting of ZSM-5, ZSM-11, ZSM-22, ZSM-23, ZSM-35, ZSM-48, ZSM-50, TS-1, TS-2, SSZ-46, MCM-22, MCM-49, FU-9, PSH-3, ITQ-1, EU-1, NU-10, silicalite-1, silicalite-2, boralite-C, boralite-D, BCA, and mixtures thereof.

In some embodiments, the acidic compound is an Al/Si mixed oxide. In some embodiments, the composition of the Al/Si mixed oxide employed as carrier is adjusted. In some embodiments, the acidic compound contains Al₂O₃ in an amount from 20 to 99 wt. %, alternatively from 30 to 80 wt. %, alternatively from 40 to 70 wt. %, based on the total weight of the acidic compound. In some embodiments, the acidic compound contains SiO₂ in an amount from 1 to 80 wt. %, alternatively from 20 to 70 wt. %, alternatively from 30 to 60 wt. %, based on the total weight of the acidic compound.

In some embodiments, the determination of the SiO₂ and Al₂O₃ content of the acidic compound is carried out by atomic emission spectroscopy, using an inductively coupled plasma (ICP-AES).

In some embodiments, the coating agent of the catalyst is selected from the group consisting of oil, inorganic hydrogel, and combinations thereof. In some embodiments, the inorganic hydrogel is silica hydrogel. In some embodiments, the oils are an aromatic-free white mineral oil. In some embodiments, the oils are based on iso-paraffins. In some embodiments, the oil has a kinematic viscosity at 20° C. of 140 to 180 mm²/s, alternatively 150 to 170 mm²/s. In some embodiments, the oil has a kinematic viscosity at 40° C. of 40 to 80 mm²/s, alternatively 50 to 70 mm²/s. In some embodiments, the oil has a kinematic viscosity at 100° C. of 5 to 15 mm²/s, alternatively 7 to 10 mm²/s. In some embodiments, the kinematic viscosity is determined according to ISO 3104.

In some embodiments, the amount of coating agent ranges from 1 to 300 wt %, alternatively from 2 to 150% wt, alternatively from 5 to 100% wt, alternatively 10-80% wt, based on amount of acidic compound. For hydrogels, the amount to be employed is the dry weight.

In some embodiments, the catalyst is made from or containing the active compound in an amount of 0.5 to 6 wt. %, alternatively 2 to 4 wt. %, based on the total weight of the catalyst.

In some embodiments, the catalyst is obtained by mixing the particulate non-porous support and the coating agent and then adding the acidic compound in the form of a powder to the mixture. In some embodiments, the mixture is heat treated, thereby obtaining the catalyst. In some embodiments, the heat treatment is carried out at a temperature of 100 to 600° C. In some embodiments, the particulate non-porous support is subjected to a drying step before being mixed with the coating agent.

In some embodiments, component (c) is a hydrogel and the catalyst is reactivated by heating, thereby allowing multiple uses and conserving resources. In some embodiments, the catalyst is reactivable by heat treatment.

### Depolymerization Product

In some embodiments, the gaseous fractions generated during pyrolysis are separated into liquid and gaseous depolymerization products. In some embodiments, the separation occurs by condensation.

### Liquid Depolymerization Product

In some embodiments, the liquid depolymerization product has a low content of aromatic compounds, alternatively a low content of polycyclic aromatic compounds and asphaltanes. In some embodiments, the liquid depolymerization product has a low content of aromatic and olefinic components and a high degree of purity.

In some embodiments, the liquid depolymerization product has the content of aromatic compounds in an amount less than 10 mol %, alternatively less than 5 mol %, alternatively no more than 3 mol %, wherein the content of aromatic components being measured as contents of aromatic protons in mol % as determined by 1H-NMR-spectroscopy.

In some embodiments, the liquid depolymerization product has a low content of olefinic compounds. In some embodiments, the liquid depolymerization product has the content of olefinic compounds in an amount less than 7 mol %, alternatively less than 5 mol %, alternatively less than 3 mol %, based on the total number of hydrocarbon protons, wherein the content of olefinic compounds being determined based on the contents of olefinic protons as determined by 1H-NMR-spectroscopy.

In some embodiments, the content of double bonds is measured by the Bromine number (BrNo.) which indicates the degree of unsaturation. In some embodiments, the liquid depolymerization product has a Bromine number, expressed as gram bromine per 100 grams of sample, of less than 150, alternatively from 10 to 100, alternatively from 15 to 80, alternatively from 20 to 70, alternatively from 25 to 100, determined according to ASTM D1159-01.

In some embodiments, the liquid depolymerization product has a boiling range from 30 to 650° C., alternatively from 50 to 250° C. In some embodiments, the depolymerization product is separated into hydrocarbon fractionations of different boiling ranges. In some embodiments, the hydrocarbon fractions are selected from the group consisting of a light naphtha fraction made from or containing C₅ and C₆ hydrocarbons having a boiling range from 30° C. and 130° C., a heavy naphtha fraction made from or containing C₆ to C₁₂ hydrocarbons having a boiling range from 130° C. to 220° C., a kerosene fraction made from or containing C₉ to C₁₇ hydrocarbons having a boiling range from 220° C. to 270° C., and other high boiling point fractions selected from the group consisting of diesel fuel, fuel oil, and hydrowax. In some embodiments, the separation occurs by distillation.

In some embodiments, the liquid depolymerization product has little to no solid residue. In some embodiments, the content of residues, upon evaporation of the liquid depolymerization product, is no more than 5 ppm (w), determined according to ASTM D381.

### Gaseous Depolymerization Product

In some embodiments, the gaseous depolymerization product has a low content of low molecular hydrocarbons such as methane or ethane. In some embodiments, the gaseous depolymerization product has higher amounts of olefins. In some embodiments, the olefins are selected from the group consisting of ethylene, propylene, and butenes. In some embodiments, the olefins are for polyolefin production. In some embodiments, the gaseous depolymerization product has a high content of olefins selected from the group consisting of ethylene, propylene, and butenes, a low content of saturated low molecular hydrocarbons, or both. In some embodiments, the hydrocarbons have the formula CₙH₂ₙ₊₂ wherein n is a real number ranging from 1 to 4.

In some embodiments, the gaseous depolymerization has a content of methane of at most 6 wt. %, alternatively at most 4 wt. %, alternatively at most 3 wt. %, alternatively at most 2 wt. %, alternatively at most 0.5-1.5 wt. %, based on the total weight of the gaseous depolymerization product.

In some embodiments, the gaseous depolymerization product has a high amount of low molecular olefinic compounds. In some embodiments, the low molecular olefinic compounds are of the CₙH₂ₙ variety with n=2-4. In some embodiments, the gaseous fraction is used directly as feedstock for further processing in a cracker downstream, for example, a raw gas compressor, thereby obtaining purified monomer streams, and thereafter for the subsequent production of polymers, thereby bypassing energy-consuming stream cracking ovens and reducing the output of CO₂. In some embodiments, the gaseous depolymerization product has a content of compounds of the formula CₙH₂ₙ (olefins) with n=2-4 of at least 50 wt. %, alternatively at least 60 wt. %, alternatively at least 65 wt. %, alternatively at least 70 wt. %, alternatively at least 75 wt. %, based on the total weight of the gaseous depolymerization product.

In some embodiments, the gaseous depolymerization product has small quantities of HCl, HCN, H₂S, H₂O, NH₃, or COS. In some embodiments, the quantities of HCl, HCN, H₂S, H₂O, NH₃, or COS are separated in a refining step before introduction to the steam cracker downstream segments.

In some embodiments, the depolymerization process yields a liquid depolymerization product with low contaminants. In some embodiments, the liquid depolymerization product is used as Steam Cracker feed or fuel.

In some embodiments, the step of sorting of the post-consumer automotive waste:
lowers the contaminants for improving catalyst efficiency;
facilitates a high quality product, having low contaminants content (N, S, Cl, metals) for direct use as steam cracker feed and/or clean fuel;
enables a higher portion of material to be recycled as metals, as engineering plastics PCR for mechanical recycling;
facilitates light olefin rich gaseous products;
facilitates a low residue/char side product from depolymerization; or
facilitates recovery of fillers from residue to recycled material.

The present disclosure will be explained in more detail with reference to the examples provided below.

### EXAMPLES

The following analytical methods were employed:

1) GC MS was used for liquid and gas analysis.

2) Char residue was determined according to mass balance after decoking the residues of the reactor at 800° C.

3) Liquid contents were characterized using simulated distillation (SimDist) analysis according to ASTM D 7213:2012. Final boiling point (FBP), boiling temperature at 50% and initial boiling point (IBP) were taken from SimDist.

4) The total content of unsaturated components in the liquid condensates were characterized via Bromine number determination using an 848 Titrino Plus (Metrohm A G, Herisau, Switzerland) equipped with a double PT-wire electrode which had integrated a PT1000 temperature sensor, and a 10 ml burette, in accordance with ASTM D1159-01 as described in Metrohm Application Bulletin 177/5e, December 2018. The Bromine number (BrNo.) represented the amount of bromine in grams absorbed by 100 grams of a sample.

5) 1H-NMR analysis was conducted by dissolving a sample of the liquid condensate in CDCl3 and characterizing the sample using proton NMR spectroscopy. Aromatic, olefinic and aliphatic protons were assigned according to the chemical shifts summarized in Table 1:

TABLE 1
Integral Regions in 1H-NMR spectroscopy

| Peak Assignment | 1H Chemical Shift (ppm) |
|---|---|
| I₁ (Aromatic Protons) | 8.25-7.27 |
| CDCl₃ -Solvent | 7.26 |
| I₂ (Aromatic Protons) | 7.25-6.60 |
| I₃ (Olefinic Protons - Type 2) | 6.60-5.95 |
| I₄ (Olefinic Protons - Type 1) | 5.95-5.67 |
| I₅ (Olefinic Protons - Type 2) | 5.67-5.35 |
| I₆ (Olefinic Protons - Type 3) | 5.35-5.15 |
| I₇ (Olefinic Protons - Type 1) | 5.15-4.85 |
| I₈ (Olefinic Protons - Type 4) | 4.85-4.40 |
| I₉ . . . (Paraffinic Protons) | 4.40-0.25 |

The listed types of olefinic protons were assumed to correspond to the following structures:

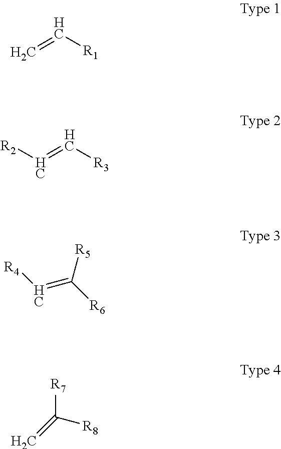

The amount of aromatic, olefinic and aliphatic protons were determined based on the assigned peak integrals according to the following equations:

$$Mol \% Aromatic Protons = [ ( {I}_{1} + {I}_{2} ) / ( {I}_{1} + {I}_{2} + {I}_{3} + {I}_{4} + {I}_{5} + {I}_{6} + {I}_{7} + {I}_{8} + {I}_{9} ) ] \%$$

$$Mol \% Olefinic Protons Type 1 = [ ( {I}_{4} + {I}_{7} ) / ( {I}_{1} + {I}_{2} + {I}_{3} + {I}_{4} + {I}_{5} + {I}_{6} + {I}_{7} + {I}_{8} + {I}_{9} ) ] \%$$

$$Mol \% Olefinic Protons Type 2 = [ ( {I}_{3} + {I}_{5} ) / ( {I}_{1} + {I}_{2} + {I}_{3} + {I}_{4} + {I}_{5} + {I}_{6} + {I}_{7} + {I}_{8} + {I}_{9} ) ] \%$$

$$Mol \% Olefinic Protons Type 3 = [ ( {I}_{6} ) / ( {I}_{1} + {I}_{2} + {I}_{3} + {I}_{4} + {I}_{5} + {I}_{6} + {I}_{7} + {I}_{8} + {I}_{9} ) ] \%$$

$$Mol \% Olefinic Protons Type 4 = [ ( {I}_{8} ) / ( {I}_{1} + {I}_{2} + {I}_{3} + {I}_{4} + {I}_{5} + {I}_{6} + {I}_{7} + {I}_{8} + {I}_{9} ) ] \%$$

$$Mol \% Paraffinic Protons = [ ( {I}_{9} ) / ( {I}_{1} + {I}_{2} + {I}_{3} + {I}_{4} + {I}_{5} + {I}_{6} + {I}_{7} + {I}_{8} + {I}_{9} ) ] \%$$

6) The water content of the catalyst was determined using a Sartorius MA45 (Sartorius AG, Goettingen, Germany) on a sample of 0.5 to 1 g at 180° C.

7) For the determination of a pH value of the hydrodepolymerization products, a liquid sample of the hydrodepolymerization product was extracted with water in a volume ratio water:sample of 1:5. The pH value of the aqueous solution was measured.

8) Particle size distribution of the particulate non-porous support and the catalyst were determined according to Coulter counter analysis in accordance with ASTM D4438. 9) Properties of the organic waste material feedstock were determined as follows:

Samples of from 20 to 100 g of the polymeric waste were milled and analyzed. Alternatively, a pelletized sample of the polymeric waste was analyzed. The following methods were used:

i) Total Volatiles (TV) were measured as the weight loss of a 10 g sample at 100° C. and after 2 hours at 200 mbar.

ii) Water content was determined by Karl-Fischer titration, using an apparatus from Metrohm 915 KF Ti-Touch equipped with a PT100 indicator electrode for volumetric KF titration according to Metrohm Application Bulletin 77/3e in compliance with ASTM E203.

iii) IR-Spectroscopy was used for a qualitative identification of various polymers (PP, PE, PS, PA, PET, PU, and Polyester) and additives such as CaCO₃.

iv) Standard elemental analysis was used for determination of wt. % of H, C, N (DIN 51732:2014-07) and S (tube furnace, ELTRA GmbH, Haan, Germany, DIN 51724-3:2012-07).

v) 1H-NMR was used for determining the composition of polymers soluble in solvents for recording a 1H-NMR spectrum: PE/PP balance (copolymers were also included), PET, PS.

vi) Ash Content analysis of plastics was determined at 800° C. according to DIN EN ISO 3451-1 (2019-05).

vii) Bulk density of the polymer waste was determined according to DIN 53466.

viii) Corrosivity was determined as the pH value of an aqueous solution after a contact time of 3 h (5 g sample in 50 ml distilled water).

ix) Inductively coupled plasma atomic emission spectroscopy (ICP-AES) was used for quantitative element determination (total chlorine content, content of Si or metals).

x) The ash content of a liquid feedstock such as pyrolysis oil, was measured according to ASTM D482-19.

### Catalyst 1

The catalyst was prepared as follows:

25.0 kg of sand were placed into a 60 L steel barrel with screw cap and equipped with a Teflon inlay. 500 ml water were added (corresponding to 2.0 wt % with respect to sand) and the drum was placed on a Drum Hoop Mixer and rotated for 1 hour (about 100 rpm). 24.5 kg of the resulting mixture was placed in another drum. 1000 g of a 1:1 milled free-flowing mixture of silica hydrogel and Zeolite Beta, as the acidic compound (corresponding to a 2 wt % loading), were added. The drum was placed on a drum hoop mixer and rotated for 1 hour (about 100 rpm). At the end of the mixing process, a free-flowing catalyst was obtained with an even distribution of the particles of the acidic compound on the surface of the sand particles. The resulting mixture was dried at 120° C. vacuum for 6 h.

The silica hydrogel was prepared according to European Patent No. EP1290042, example 1. The solid content of the hydrogel sample was 20 wt %. The D50 of the milled mixture of silica hydrogel and acidic components were between 80-100 μm, in accordance with ASTM D4438.

The sand had a particle size distribution as summarized in Table 1 below, with 99% of the particles being smaller than 3 mm. Prior to use in formation of the catalyst, the sand was pre-dried at 80° C. for 24 h in a drying oven with circulating air.

TABLE 1
Particle size distribution

| | Sand, wt. % |
|---|---|
| >1400 μm | 40.55% |
| >1400 μm->1000 μm | 55.30% |
| <1000 μm | 4.15% |

Zeolyst Beta (CP811E-75), was commercially available from PQ Corporation, Malvern, PA, USA

### Catalyst 2

The catalyst was prepared according to the same procedure described for Catalyst 1, with the difference that silica hydrogel was not used as a coating agent.

### Feedstock:

The following APW containing materials were obtained as feedstocks:

### Comparative Feedstock A

End-of-use cars were shredded in scrap car recycling plant. The metals (density >2.5 g/cm³) were separated by magnetic, density, or both separation, thereby obtaining a plastic-rich fraction (density <2.0 g/cm³).

### Exemplary Feedstock A1

End-of-use cars were shredded in scrap car recycling plant. A plastic-rich fraction with a density≤1.06 g/cm³ was separated by density separation.

### Comparative Feedstock B

Mixed automotive plastic waste consisting of whole or largely intact components (non-shredded, dismantled) from repair shops or scrap car recycling companies.

### Comparative Feedstock C

Mixed automotive plastic waste consisting of whole or largely intact components (non-shredded, dismantled) from repair shops or scrap car recycling companies. Metal-containing parts and cables were manually separated. In some instances, the metal-containing parts were electronic parts.

### Exemplary Feedstock B1-B2 and Comparative B3-B4

The sorting of the mixed automotive plastic waste from repair shops was based on applications of specific polymers and polymer composites for specific components.
Colorless tanks (for example, cooling water expansion tanks) with a density <1.0 g/cm³ were assigned to the polyethylene fraction. Black fuel tanks and black fuel hose with a density <1.0 g/cm³ were assigned a fraction of halogenated materials;
Unpainted exterior parts (for example, wheel house liners, wheel arch, and bumper guide rails) with a dimension along one axis of >10 cm and density <1.06 g/cm³ were assigned to the PP talc and mineral filled fraction. Unpainted exterior parts (for example, wheel house liners, wheel arch, and bumper guide rails) with a dimension along one axis of >10 cm and density of 1.06-1.3 g/cm³ were assigned to an ASA, ABS, PC/ABS, and POM fraction after a manual separation of polyamide parts according to the material stamp on the parts. The polyamide parts were assigned to a PA fraction;
Engine covers with a dimension along one axis of >10 cm and density of 1.06-1.3 g/cm³ were assigned to the PA fraction;
Painted exterior parts (for example, grilles, door panels, and bumpers) with a dimension along one axis of >10 cm and a density <1.06 g/cm³ were assigned to the PP talc and mineral filled fraction. Painted exterior parts (for example, grilles, door panels, and bumpers) with a dimension along one axis of >10 cm and a density of 1.06-1.3 g/cm³ were assigned to the ASA, ABS, PC/ABS, and POM fraction after a manual separation of polyamide parts according to the material stamp on the parts. The polyamide parts were assigned to the PA fraction;
Flat unpainted exterior parts with a dimension along two spatial axes of >30 cm each (for example, underbody protection for engines) and a density of 1.04-1.13 g/cm³ were assigned to a polypropylene glass fiber fraction;
Unpainted interior parts (for example, instrument panel carrier and covers) with a dimension along one axis of >10 cm and density <1.06 g/cm³ were assigned to the PP talc and mineral filled fraction. Interior parts with a backfoamed surface (for example, dashboards) that have a Shore hardness <50 (Shore D), a dimension along one axis of >10 cm, and density of 0.9-1.06 g/cm³ were assigned to the halogenated polymers and electronic fraction;
Components with a density >2.0 g/cm³ were assigned to the metal-rich parts fraction. Electronic parts, cables and electric insulations with a density of 1.3-2.0 g/cm³ were assigned to the halogenated polymers and electronic fraction;
Interior parts with a dimension along one axis of >10 cm and a density of 1.06-1.3 g/cm³ were assigned to the ASA, ABS, PC/ABS, and POM fraction after a manual separation of polyamide parts according to the material stamp on the parts. The polyamide parts were assigned to a PA fraction;
Completely foamed and woven parts with a density <0.88 g/cm³ and rubber seals were assigned to an “unknown” fraction.

The filler contents of the PP talc and mineral filled fraction and the PP glass fiber fraction were determined based on the material density (polypropylene 0.91 g/cm³; talc 2.6 g/cm³, glass fibers 2.5 g/cm³).

The properties of the feedstocks averaged on analysis of three samples are summarized in Table 2.

TABLE 2

| | A | A1 | B | B1 | B2 | B3 | B4 | C |
|---|---|---|---|---|---|---|---|---|
| | [kg] | [kg] | [kg] | [kg] | [kg] | [kg] | [kg] | [kg] |
| Total mass of sample | 101.5 | 41.9 | 77.5 | 39.0 | 49.0 | 6.5 | 8.5 | 65.5 |
| PP (unfilled and mineral | 36.3 | 35.1 | 37.5 | 37.5 | 37.5 | 0.0 | 0.0 | 36.0 |
| filled) | | | | | | | | |
| thereof talc | 6.5 | 6.0 | 6.4 | 6.4 | 6.4 | 0.0 | 0.0 | 6.2 |
| PP glass fiber reinforced | 4.1 | 3.8 | 10.0 | 0.0 | 10.0 | 0.0 | 0.0 | 5.2 |
| thereof glass fibers | 1.0 | 0.8 | 2.4 | 0.0 | 2.4 | 0.0 | 0.0 | 2.2 |
| PE | 2.2 | 2.2 | 1.5 | 1.5 | 1.5 | 0.0 | 0.0 | 1.6 |
| PC/PET, POM, ASA, ABS, | 4.6 | 0.0 | 6.5 | 0.0 | 0.0 | 6.5 | 0.0 | 11.9 |
| PC/ABS | | | | | | | | |
| PA | 13.5 | 0.8 | 3.0 | 0.0 | 0.0 | 0.0 | 0.0 | 5.6 |
| halogenated polymers, | 13.3 | 0.0 | 8.5 | 0.0 | 0.0 | 0.0 | 8.5 | 1.2 |
| electronic | | | | | | | | |
| metals-rich parts | 14.2 | 0.0 | 6.5 | 0.0 | 0.0 | 0.0 | 0.0 | 0.0 |
| unknown | 13.3 | 0.0 | 4.0 | 0.0 | 0.0 | 0.0 | 0.0 | 4.0 |
| Sum mass of polyolefinic | 42.6 | 41.1 | 49.0 | 39.0 | 49.0 | 0.0 | 0.0 | 42.8 |
| compounds incl. filler | | | | | | | | |
| Sum mass of polyolefinic | 35.1 | 34.3 | 40.2 | 32.6 | 40.2 | 0.0 | 0.0 | 34.4 |
| compounds w/o filler | | | | | | | | |
| Wt % polyolefinic | 34.6% | 81.9% | 51.9% | 83.6% | 82.0% | 0.0 | 0.0% | 52.5% |
| compounds | | | | | | | | |

The feedstock and catalyst were introduced into a reactor device equipped with heating units, gas discharge units, a solid discharge unit, a condensation device and a screw for homogenously mixing the reactor content during depolymerization. Conditions of the depolymerization conducted are summarized in Table 3. The resulting gaseous fractions were separated into liquid and gaseous depolymerization products by condensation. The amounts of the resulting fractions are shown in Table 3.

TABLE 3
Process parameter and mass balance

| | Temp | Time | | | | | | | |
|---|---|---|---|---|---|---|---|---|---|
| Run# | ° C. | (min) | Cat# | Feedstock | % Liquid | % H₂O | % Gas | % Residue | % loss |
| Comp. 1 | 450 | 30 | none | C | 46.6 | 2.0 | 16.5 | 25.8 | 9.1 |
| Comp. 2 | 450 | 30 | none | A | 28.7 | 1.7 | 19.8 | 49.0 | 2.0 |
| IE 3 | 450 | 30 | none | A1 | 42.4 | 0.8 | 21.5 | 34.3 | 2.0 |
| Comp. 4 | 450 | 30 | 1 | C | 43.6 | 2.0 | 19.5 | 29.8 | 5.1 |
| Comp. 5 | 450 | 30 | 1 | B | 45.4 | 0.5 | 23.5 | 30.3 | 0.3 |
| IE 6 | 450 | 30 | 1 | B1 | 31.3 | 0.9 | 55 | 15 | 2.3 |
| Comp. 7 | 450 | 30 | none | B | 43.4 | 0.6 | 22.2 | 33.0 | 0.8 |
| IE 8 | 450 | 30 | none | B1 | 50.6 | 0.2 | 23.9 | 31.9 | −6.6 |
| Comp. 9 | 450 | 30 | 1 | B3 | 40.8 | 1.5 | 4.5 | 51.1 | 2.1 |
| Comp. 10 | 450 | 30 | 2 | B | 57.7 | 1.4 | 21.7 | 17.6 | 1.6 |

Table 3 indicated that exemplary runs show a high amount of liquid+gas depolymerization product and a lower amount of residue with respect to comparative run made with a different feedstock under the same conditions.

The liquid depolymerization product from runs C1, C2 and C4 contains high amount of heteroatoms and halogens, thereby preventing use of the resulting depolymerization products as cracker feed.

The gaseous depolymerization products obtained were further analyzed. The results of the analysis are summarized in Table 4.

TABLE 4
Analysis of the pyrolysis gas

| Run | # | Comp. 5 | Comp. 9 | IE 6 | IE7 | Comp 10 |
|---|---|---|---|---|---|---|
| H₂ | [wt %] | 1.1 | 0.1 | 0.3 | 0.3 | 0.7 |
| CO | [wt %] | 0.0 | 6.7 | 0.0 | 0.0 | 2.5 |
| CO₂ | [wt %] | 34.8 | 83.9 | 2.0 | 6.6 | 28.2 |
| CH₄ | [wt %] | 7.3 | 1.6 | 1.8 | 3.6 | 3.5 |
| C₂H₆ | [wt %] | 8.1 | 0.5 | 3.0 | 7.0 | 6.0 |
| C₂H₄ | [wt %] | 13.8 | 1.3 | 5.5 | 3.6 | 3.6 |
| C₃H₈ | [wt %] | 0.2 | 0.0 | 11.8 | 7.3 | 5.7 |
| C₃H₆ | [wt %] | 12.3 | 2.2 | 30.5 | 36.2 | 24.5 |
| Butanes | [wt %] | 15.4 | 1.1 | 23.2 | 18.4 | 11.1 |
| Butenes | [wt %] | 7.0 | 2.5 | 22.0 | 17.0 | 14.1 |

Table 4 indicated that exemplary runs 6-7 show the lowest amount of CO and CO₂, a low amount of CH₄ combined with the highest amount of higher alpha olefins such as propylene and butene as well as the saturated homologs propane and butanes.

1. A process for the recycling of automotive plastic waste comprising the steps of:
(i) sorting the automotive plastic waste (APW), thereby obtaining a plastic waste fraction containing at least 60% wt of a mixture of polyethylene (PE) and polypropylene (PP);
(ii) shredding, pelletizing, or both the fraction, thereby obtaining a plastic feedstock having a bulk density higher than 100 g/l;
(iii) depolymerizing the feedstock at 300-500° C., in the optional presence of a catalyst, thereby obtaining a depolymerization product; and
(iv) collecting the depolymerization product and separating the depolymerization product into a liquid stream and a gaseous stream.

2. The process according to claim 1, wherein the sorted APW fraction has a content of PE and PP higher than 70% wt.

3. The process according to claim 1, wherein, in the sorted APW, the cumulative amount of non-olefin polymers is lower than 5% wt.

4. The process according to claim 1, wherein, in the sorted APW, the cumulative amount of non-olefin polymers is lower than 3% wt.

5. The process according to claim 1, wherein step (i) is carried out via an automatic separation technique.

6. The process according to claim 1, wherein the APW feedstock originates from scrap of end-of-use cars.

7. The process according to claim 6 further comprising
sorting the APW feedstock by density, thereby producing a fraction having density lower than 2.0 g/cm³; and
separating the fraction by density, thereby isolating a polyolefin rich fraction having density lower than 1.06 g/cm³.

8. The process according to claim 1, wherein the APW feedstock originates from repair shop parts and sorting is based on applications of specific polymers, density and polymer composition for specific components.

9. The process of claim 1, wherein, after step (ii), the plastic feedstock has a bulk density higher than 300 g/cm³.

10. The process of claim 9, wherein, after step (ii), the plastic feedstock has a particle size from 1 to 100 mm.

11. The process according to claim 1, wherein the depolymerization step (iii) is carried out in the presence of a catalyst.

12. The process according to claim 11, wherein the catalyst comprises an acidic compound deposited on a particulate non-porous support with the aid of a coating agent.

13. The process according to claim 1, wherein the gaseous depolymerization product has a content of compounds of the formula CₙH₂ₙ with n=2-4 of at least 50 wt. %.

14. The process according to claim 1, wherein the liquid depolymerization product, upon evaporation, has a content of residues of no more than 5 ppm (w), determined according to ASTM D381.

15. A feedstock for a recycling process comprising:
a sorted automotive plastic waste fraction comprising
at least 60% wt, of a mixture of polyethylene (PE) and polypropylene (PP);
less than 5% wt of polymers deriving from monomers comprising heteroatoms (non-olefin polymers); and
less than 1% wt of metals selected from the group consisting of iron, copper, aluminum, magnesium, and chromium.
